(19) United States
(12) Patent Application Publication
(10) Pub. No.: US 2018/0246759 A1
(43) Pub. Date: Aug. 30, 2018

(54) DATA VISUALIZATION AND ACCUMULATION DEVICE FOR CONTROLLING STEPS IN CONTINUOUS PROCESSING SYSTEM

(71) Applicant: Akihisa Minamitani, Hyogo (JP)

(72) Inventors: Akihisa MINAMITANI, Hyogo (JP); Tomio MINAMITANI, Hyogo (JP); Takahiro MINAMITANI, Hyogo (JP)

(21) Appl. No.: 15/967,880

(22) Filed: May 1, 2018

Related U.S. Application Data
(63) Continuation of application No. 14/440,675, filed on Aug. 4, 2015.

(30) Foreign Application Priority Data
Nov. 5, 2012 (JP) 2012-243566

(51) Int. Cl. G06F 9/48; D06F 31/00; G06F 9/46; G06Q 50/04; D06F 93/00; G06Q 10/06; G05B 19/418

(52) U.S. Cl. CPC G06F 9/4887; D06F 31/00; Y02P 90/30; Y02P 90/20; G06F 9/466; Y02P 90/26; D06F 93/00; G06Q 10/06395; G05B 2219/31472; G05B 19/41865; G06Q 50/04

(57) ABSTRACT

A daily operation data recording matrix device for visually presenting and accumulating daily visual Icon data descriptive of process operations in the order of operational events in a continuous processing system. An array includes a two-dimensional matrix array made up of rows and columns, one of the rows and columns in the matrix array being divided in hour units of a daily length of an operation and the other rows and columns being divided by a time span based on the length of one batch time of an operation work. The rows and columns form respective batch cells for indication of each of the process operations, and the batch cells are used to visually accumulate by the visual Icons in the matrix array all the operation works in the order of the operational events.

### FIELD OF INVENTION

The invention relates to a daily operation data recording matrix device in a continuous processing system which is used for easy optimization of operations by Icon visual data and the invention also relates to a method of optimizing processes in a continuous processing system by using the visual operation data or result on the recording matrix device. It is useful for a continuous laundry processing system composed of a sorting step, a washing step, a drying step and a finishing step in a laundry (linen-supply) factory.

### BACKGROUND OF INVENTION

Generally, in a continuous washing and finishing system of a conventional laundry factory, firstly soiled laundries should be sorted before washing into at least two groups; one is a kind for full drying items and the other kind for semi-drying items depending on the kind of items. For example, the full drying items include kinds of towels, pillow covers, bath mats and so on, which need not a process of ironing for finishing, while the semi-drying items include kinds of sheets, doctor's smocks, hospital gowns and wrapping clothes and so on, which need a process of ironing for finishing. Therefore, at a stocking lane before washing, all the soiled laundries should be sorted into two groups and loaded into each bag of the two groups for the full drying step and the semi-drying step. Laundries of the stocked bags for the full drying step are conveyed to first continuous washing machines, and the other of stocked bags for the semi drying step are conveyed to second continuous washing machines. FIG. 1 is a schematic perspective view showing, a conventional laundry factory as one of the typical continuous processing system, where continuous washing machines, drying machines and finishing machines are connected for the full drying lane and the semi-drying lane respectively. In case of hospital laundries, the continuous processing system comprises 1) the full drying lane composing of a process flow extending from a first floor to a second floor and 2) the semi-drying lane composing of a process flow extending only in a first floor. The items to be washed are sorted and processed by item to item. As shown in FIG. 1, the full drying lane is set up by a step of a continuous washing, a step of drying, and a step of fold finishing, wherein the full dry items are processed in the following order as shown in FIG. 1; a step of packing→a step of charging conveyor→a step of a first washing machine 2→a step of hydraulic dehydrator 3→a step of conveyor (Lifting & Traveling) L1→a step of dryer (2 Lots) 4→a step of conveyor (Distributing) C1→a step of towel folder 5→a step of Finished product conveyor C3-1→a step of binding machine→a step of shipment waiting. On the other hand, the semi-drying lane is also set up for a kind of sheets, doctor's smock, hospital gowns and wrapping clothes, which comprises a step of a continuous washing→a step of pressure or centrifuge drying→a step of ironing in a state of half drying, wherein the shake items such as sheets are processed in the following order as shown in FIG. 1; a step of packing→a step of charging conveyor→a step of a second washing machine 12→a step of Hydraulic dehydrator 13→a step of conveyor (Lifting & Traveling) L1→a step of dryer (1 Lot) 14→a step of conveyor (Distributing) C2→a step of spreader 15→a step of roll 16→a step of folder 17→a step of finished product conveyor C3-2→a step of binding machine→a step of shipment waiting. Further, the doctor's smocks are processed in the following order; a step of packing→a step of charging conveyor→a step of the second washing machine 12→a step of hydraulic dehydrator 23→a step of conveyor→a step of dryer (1 Lot) 24→a step of wagon→a step of lift conveyor L3→a step of finishing room 25→a step of shipment waiting. Therefore, after washing, each item is conveyed and finished through the necessary steps depending on the different items.

In the controlled continuous washing machine system, however, there are many problems to stop the process or slow down the process, which is caused by some accidents or reasons such as mechanical failure and bad operators, resulting in such a problem swearing back to the first washing step and slowing down of the first washing step which leads to a time loss of the whole process.

In the conventional continuation wash finishing system, the following faults occur, for example, (1) Processing of the finishing roll for sheet is slow, and so pre-stock lane become filled, (2) Destination of the sheet in the tumbler is lost and the discharge becomes improper (3) A lift conveyer becomes stopped and so a sheet stagnates (4) Such interlock retroacts to the upper stream (the first washing step) sequentially and some of continuation washing machine stop, and finally (5) Most Laundry machines stop and the amount of completed product is affected directly

Therefore, according to the patent literature 1, a control process has been proposed so as not to stop the whole processes by using a transfer control system to make possible change control of a call order of a sling bag from a sling bag stock lane even if the above failure would happen. On the other hand, according to the prior patent literature 2 there has been proposed a PC device for getting a total number of batches for each items, a finishing number, a total energy consumption and a total manpower cost by inputting automatically signals of items to be charged into the washing machines and the output signals of items to be discharged from the washing machines and finally calculating the total number of clean linen and the total number of defective linen in each of items.

### PRIOR LITERATURE

Patent literature 1; (Japanese unexamined publication 1995-178300)
Patent literature 2; (Japanese unexamined publication 2006-26035),

### DISCLOSURE OF INVENTION

However, the former invention is provided with control of a wash sling bag stock lane which stocks item bags before washing, where a call order of the next sling bag is controlled and changed depending on the number of bags before washing, but it does not take the visual comparison of the order data, so that the process optimization of whole systems is difficult and has not been realized yet. The latter invention is provided with a PC controller where the charged number of items, the finished number of items and the defective number are recorded and calculated by item to item basis, but any other conditions causing the loss of system has not been recorded and viewed on the matrix although the total number to be processed can be accumulated, whereby the process optimization has not been completed yet.

Therefore, after a lot of research, the inventors have found that, firstly visualization of the data result or history especially in the first step on the matrix device is important and secondly if the daily visual data in the first step of the whole continuous process can be obtained, the visual optimization analyze can be realized (whether matrix should be filled by Icons or some blanks (not filled by Icons) in the matrix is reasonable). That is, the matrix in first step indicating the operation result or history shows whether the matrix cells are filled or not and if the problems occurred in the whole processes and the operation loss did swear back to the first step, we can analyze the reason why the first step data in the matrix shows too many blanks (not filled by the operation data) than we expect and we can guess how the total processes were running or going according to the result or history in the first step process.

### Means to Solve the Problem

According to the first embodiment of the invention, there is provided a matrix array for accumulating visual operation data and realizing easy optimized operation control from comparison of the daily data result or history. That is, the first embodiment of the invention provides a daily operation data recording matrix device for visually presenting and accumulating daily visual Icon data descriptive of process operations in the order of operational events in a continuous processing system, which array comprises a two-dimensional matrix array made up of rows and columns; ones of the rows and columns in the matrix array being divided in hour units of daily length of operation and while the others of such rows and columns are divided by the time span based on one based on the length of one batch time of the operation work, the rows and columns forming respective batch cells for indication of each of the process operations; the batch cells being used to visually accumulate by the visual Icons in the matrix array all the operation works in the order of the operational events.

According to the second embodiment of the invention, there is provided a method of optimizing the processes by using the matrix array that is a daily operation data recording device for visualization and accumulation of operation works in order of operation time in a continuous processing system. That is, the second embodiment of the invention provides a method of optimizing the daily operation in a continuous washing system at least comprising a sorting step of laundries, a washing step of laundries, a drying step of laundries and a finishing step of laundries and the whole steps are controlled, which comprises a step of providing a daily operation recording matrix device for the first washing step, a step of recording each daily washing process operations into one of the rows and columns of the matrix device in the order of washing events in the first washing step, a step of visually accumulating each daily washing process operations in one of rows and columns divided by the time span based on the length of one batch time of the operation work, a step of comparing the batch cell or cells filled by each of the washing events Icon with the batch cell or cells not filled by the Icon, and a step of evaluating a result or history of the washing operation.

### Function and Effect of the Invention

According to the present invention, although the processing loss in the multiple item continuous processing steps swears back to the first step, signals of icons shown on the matrix indicate what kinds of the items and how the items are processed and have been processed in the first step, so that visual data analyzation by eye makes it possible to detect how the whole process is going by the first step result. That is, in case of a horizontal length of the cell in the matrix showing one batch processing time, an icon existing in one of the cells in the matrix means and shows the item shown by the icon has been processed while no icon existing in one of the cell in the matrix means the item shown by the icon has not been processed. Therefore, existence of icons and no icon in the cells of the matrix can indicate respectively the fact that the item has been processed and the fact that no item has been processed, so we can confirm how all the steps in the first step of the whole processes is going. In case of the first process, if there is no existence of icon in the cell or cells of the first step, it will be obvious by eye contact that there are some more available capacities in the first step. Therefore, according to the present invention, it is possible to optimizing the first step by making more entry of the operation in the first step. According to the present invention, the operation history is visualized and accumulated in the matrix, so that it is easy to optimize the process control.

In the present invention provided with the second step, if the second step may be provided with a time-matrix array device for data visualization, co-operation or relation between the first step and the second step is easy to be analyzed as to how the second step was running or going and how the second step affects the first step.

In the present invention provided with a third step, if the third step may be provided with a time-matrix array device for data visualization, co-operation or relation between the first step and the third step is easy to be analyzed as to how the third step was running or going and how the third step affects the first step.

In order to facilitate interactions between the first step, the second step and the third step, the present time-matrix array is preferably provided with cells wherein a horizontal length of the cell may be divided by a time span corresponding to or based on one batch time of the first step, because the whole process can be related on a time series basis to the first step. In such case, the progress of whole process can be visualized and the operation of whole process can be optimized with ease. In the time matrix, while a vertical length of the cell is generally divided by a time unit of the operation time span, a horizontal length may be divided by the time unit span. In such a case, a vertical length of the cell is divided by a time span corresponding to or based on one batch time. In either one of these cases, the same function and effect can be obtained. The present invention of the multiple item continuous process system can be applied to a continuous washing, drying and finishing system wherein the first step is provided with one or plural of washing machines and the second step is provided with plural drying machines for drying. The third step is provided with one or plural finishing machines for finishing each of items, so the whole process should visualize and accumulate the data by using the present time-matrix array.

### BRIEF DESCRIPTION OF DRAWINGS

FIG. 1 is a schematic perspective view of a conventional continuous washing, drying and finishing factory.

FIG. 2A is a schematic layout of the first floor of the factory applied by the embodiment of the present invention,

FIG. 2B is a schematic layout of the second floor of the factory applied by the embodiment of the present invention,

FIG. 3A is a plane view of a time-matrix indicating a progress of the first continuous washing machines in the first step of the continuous processing system,

FIG. 3B is a plane view of a time-matrix indicating a progress of the second continuous washing machines in the first step of the continuous processing system,

FIG. 4A-1 is a plane view of a data recording matrix device according to the present invention indicating a progress of a first drying machines for full drying item in the second step of the continuous processing laundry system,

FIG. 4A-2 is a plane view of a data recording matrix device according to the present invention indicating a progress of a second drying machine for full drying item in the second step of the continuous processing laundry system,

FIG. 4A-3 is a plane view of a data recording matrix device according to the present invention indicating a progress of a third drying machine for full drying item in the second step of the continuous processing laundry system,

FIG. 4A-4 is a plane view of a data recording matrix device according to the present invention indicating a progress of a fourth drying machine for full drying item in the second step of the continuous processing laundry system,

FIG. 4B-1 is a plane view of a data recording matrix device according to the present invention indicating a progress of a third drying machine for half drying item such as hospital gown or sheets in the second step of the continuous processing laundry system,

FIG. 4B-2 is a plane view of a data recording matrix device according to the present invention indicating a progress of a second drying machine for half drying item such as hospital gown or sheets in the second step of the continuous processing laundry system,

FIG. 4B-3 is a plane view of a data recording matrix device according to the present invention indicating a progress of a third drying machine for half drying item such as hospital gown or sheets in the second step of the continuous processing laundry system,

wherein

Icon—Ic; sheets—S; Musashi sheets—Ms; OS sheets—Os; OS color sheets—Oc; Musashi wrapping clothes—Mw; Wrapping clothes white—Ww; Wrapping clothes color—Wc; Wrapping clothes pattern—Wp; Pillow—Pi; Hospital gown—Hg; Doctor's smoke—Ds, Cotton brankt—Cb; New—Ne; Rewash—Rw; OS pillow—Op; Hospital gown—Hg; Towel—To, Bath towel—Bt; Towelkt—Tk; Bed pad—Bp; OS Wrapping clothes—Ow; Towel color new—Tn.

FIG. 5-A is a plane view of a data recording matrix device according to the present invention indicating a progress of laundry folding machines for full drying item such as towels in the third step of the continuous processing laundry system,

FIG. 5-B is a plane view of a data recording matrix device according to the present invention indicating a progress of a first finishing roll machines for half drying item such as sheets in the third step of the continuous processing laundry system,

FIG. 5-C is a plane view of a data recording matrix device according to the present invention indicating a progress of a third finishing roll machines for half drying item such as wrapping cloth in the third step of the continuous processing laundry system,

FIG. 5-D is a plane view of a data recording matrix device according to the present invention device indicating a progress of a second finishing roll machines for half drying item such as hospital gown in the third step of the continuous processing laundry system,

FIG. 6 is an obtained data showing the progress condition of the items to be charged into a first step in the embodiment according to the invention.

### BEST MODE FOR CARRYING OUT THE INVENTION

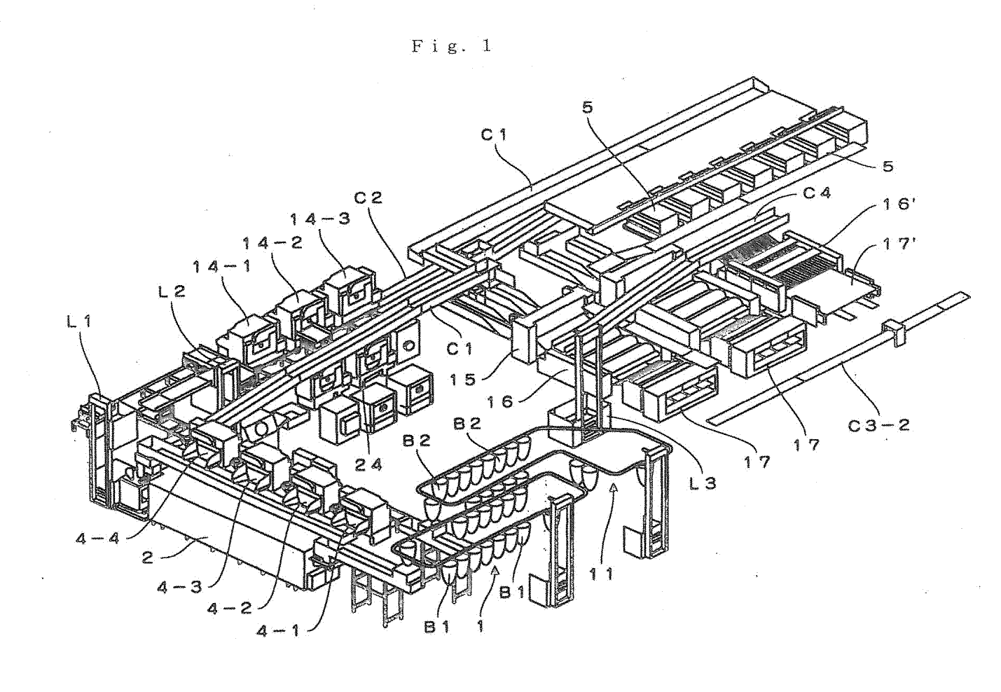

Hereinafter the present invention will be described with reference to the embodiment shown in drawings. FIG. 1 is a schematic perspective view showing the whole systems of a continuous washing, drying and finishing factory according to the invention, which is applied to a continuous washing lane of laundry from hospital which comprises a full drying lane composed of a flow from a first floor to a second floor and a half drying lane composed of a flow in a first floor. wherein items to be processed are sorted and processed by item to item. The full drying lane is applied to a kind of towels, pillow covers and bath mats and comprises a step of a continuous washing, a step of drying, a step of fold finishing, wherein the full dry items are processed in the following order; a step of Packing→a step of Charging conveyor→a step of a first washing machine 2→a step of Hydraulic dehydrator 3→a step of Conveyor (Lifting & Traveling) L1→a step of Dryer (2 Lots) 4→a step of Conveyor (Distributing) C1→a step of Towel folder 5→a step of Finished product conveyor C3-1→a step of Binding machine→a step of Shipment waiting. On the other hand, the half drying lane is applied to a kind of sheets, doctor's smock, hospital gowns and wrapping clothes and comprises a step of a continuous washing, a step of pressure or centrifuge drying, a step of ironing in a state of half drying, wherein the shake items such as sheets are processed in the following order; a step of Packing→a step of Charging conveyor→a step of a second washing machine 12→a step of Hydraulic dehydrator 13→a step of Conveyor (Lifting & Traveling) L1→a step of Dryer (1 Lot) 14→a step of Conveyor (Distributing) C2→a step of Spreader 15→a step of Roll 16→a step of Folder 17→a step of Finished product conveyor C3-2→a step of Binding machine→a step of Shipment waiting. Further, the doctor's smocks are processed in the following order; a step of Packing→a step of Charging conveyor→a step of the second washing machine 12→a step of Hydraulic dehydrator 23→a step of Conveyor→a step of Dryer (1 Lot) 24→a step of Wagon→a step of Lift conveyor L3→a step of Finishing room 25→a step of Shipment waiting.

(Step of Stocking)

Each of items to be processed before washing is sorted and charged into the bags B and is stocked in either of a first stock lane 1 or a second stock lane 2 by item to item depending on the full drying item or the half drying item.

In the stock step, there are provided with a first charging bar stock lane 1 wherein the full dry items including towels and pillow covers in the bag are transferred in sequence and also a second charging bar stock lane 11 wherein the half dry items including bathrobes, sheets and bath-mats in the bag is transferred in sequence, and each item charged in the bag are weighted and each weight signal of the items with the item name are recorded. This is the stock step.

(Step of the Continuous Washing)

The charged bag BI with the full dry items are called out in sequence from the charging bag stock lane 1 and transferred to a first continuous washing machine 2 by a charging conveyor C/V while the charged bag B2 with the half dry items are called out in sequence from the charging bag stock lane 2 and transferred to a second continuous washing machine 12. The first continuous washing machine is provided with 10 washing tubs, wherein each washing tubs were controlled according to a continuous washing order program of pre-washing, washing and rinsing for the full dry item in a manner to transfer the item from one to another washing tub in sequence and wash them in each washing tubs. The second continuous washing machine is also provided with 10 washing tubs, wherein each washing tubs were controlled according to a continuous washing order program of pre-washing, washing and rinsing for the half dry item in a manner to transfer the item from one to another washing tub in sequence and wash them in each washing tubs. This is the step of washing.

(Step of Hydrating and Drying)

The processed items such as Towels T and Shakes S from the first and the second continuous washing machines are sorted into the full dry items and the half dry items. The full dry items such as Towels T are charged from the first continuous washing machines to a hydraulic dehydrator 3 and transferred to a first dryer 4-1 to a fourth dryer 4-4 (2 lots) on a second floor by a conveyor (Lifting & Traveling) L1. The full dry operation time needs 20 to 30 minutes and may be changed depending on the thickness and the whole amounts. On the other hand, the half dry items are sorted into Doctor's smokes and Shake items such as sheets, Hospital gowns and wrapping clothes depending on necessity of ironing finish. The shake items are charged from the second continuous washing machines 12 to a hydraulic dehydrator 13 and transferred to a dryer 14-1 to a dryer 14-3 (1 lot) by a conveyor (Lifting & Traveling) L2 while the Doctor's smocks are charged from the second continuous washing machines 12 to a centrifuge dehydrator 23 and transferred to a dryer 24 by a conveyor. The half dry items such as wrapping clothes and hospital gowns and the other Shake item such as sheets need a same after-treatment, but the former items need more drying time of 7 or 8 minutes because the clothes contain more water while the latter items need less drying time of 4 or 5 minutes because the latter drying process mainly needs to freeze the clothes. Therefore, the latter drying process may be carried out by a tumbler and dryer.

(Step of finishing) The final step of the continuous washing lane is a finishing step. The full dry items such as towels are fed from a dryer 4 (2 lots) to a towel folder 5 by a distributing conveyor C1 and then subjected to a detecting process in order to get the number of finished products. After recording, the finished products are fed to a binding machine 6 and are in storage for a shipment waiting. On the other hand, although it is usually necessary to be subjected to an ironing finishing process in a state of half dry, a different step of finishing is applied depending on a kind of the item. Therefore, an item sorting is necessary. The shake items from the second continuous washing machine are transferred to a second floor by Lift L2 and are subjected to a step of drying in the dryer (1 lot) 14. Then, the dried items are fed to a spreader 15 and are irony finished by a first finishing roll 16 and are folded by a folder 17. After checking, the finished products were counted by item to item to be in storage for a shipment waiting. The hospital gowns are usually placed in a hanger and after irony finishing, folding and checking, the finished products are counted and the number is recorded. The finished products are transferred to a binding machine and are in storage for a shipment waiting. The Doctor's smocks are transferred from a dryer (1 lot) to wagon and are lifted to a second floor by a conveyor lane L3 and are fed into a doctor's smock finishing room 25 by a conveyor C4, where after checking, the finished products were counted by each unit of items to be in storage for a shipment waiting

In the continuous washing lane, a continuous step of washing to dehydrating is processed just like in a manner of process passing through a single tube. Therefore, smoothing the item out from dehydrating machines makes it possible to keep the same processing time, but sometimes the problems happen at the time when the item from the dehydrate machine is charged into a dryer through a conveyor and when the item from a dryer is fed to a finishing roll or a towel finishing site. Speaking concretely, the full dry item lane is designed in a manner that a number of dryers are provided not so as to delay the process and the ability of conveyor is setup not so as to delay the process. For example, if the drying time needs 24 minutes and one batch unit time is 3 minutes with 2 lots of dryer, at least 4 pair of dryer (2 lots) are necessary. In case that the drying time and the transferring time are different depending on the item to be processed, waiting on the conveyor for charge sometimes happens and the resulting process loss in the washing machines happens. On the other hand, in case that the drying time of almost items is shorter while the washing time is longer, the washing process does not catch up with the drying process, resulting in the process time loss caused by empty of dryer. On the contrary to this, in case that the drying time of almost items is longer while the washing time is shorter, the drying process does not catch up with the washing process, resulting in long waiting time on the conveyor and washing time loss caused by empty of washing machine.

Accordingly, considering what kind of item should be processed and how the items can be transferred by the conveyor, it is important to accumulate and analyze data of progress so as to think about what order of items would be most effective. Therefore, optimization could be realized by less number of machines, less amount of utilities (water, steam and electricity) and less operation time for workers (less waiting time)

The half dry items and Shake items are supposed to be processed by the same continuous washing machines because the both after-treatment is the same, but the operation time in the dryer (the drying time) is not the same, so that if no analyzation on the process data would be made day by day, it will be difficult to determine the daily procedure day by day because the daily throughput is not fixed, for example although the daily throughput can be counted in case that the daily throughput is determined by the delivery schedule of the customer. In almost cases, as the items to be processed in a day are in transportation to the laundry factory, it is difficult to count out the daily throughput by each kind and amount of items to be delivered. If the priority is given to what item can be processed at the present, all most of the continuous washing machines would sometimes be occupied and even if the additional items to be processed would be charged in turn into the washing machines, the resulting time lag of 40 to 60 minutes would be caused until to be discharged from the dryer. The effective operation means to make a progress of process according to a determined process time (one batch time) so as not to cause a waiting time on the conveyor as well as not to make an empty of the dryer, resulting in keeping the number of item supply enough to be handled by workers and the number of finished products enough to be delivered to the customer. Therefore, it is essential to accumulate and analyze the past process data in order to determine how to setup the schedule depending on the number of items to be processed and the number of the items to be delivered from the customer to the factory.

In the conventional linen business field, the process cost will not be changed as production increases or decreases and there has been no way to search the causes of loss without accumulation and analyzation of the process data. According to the present invention, use of the time-matrix makes it possible to accumulate and visualize the data of operation condition in each steps to make it possible to analyze the data.

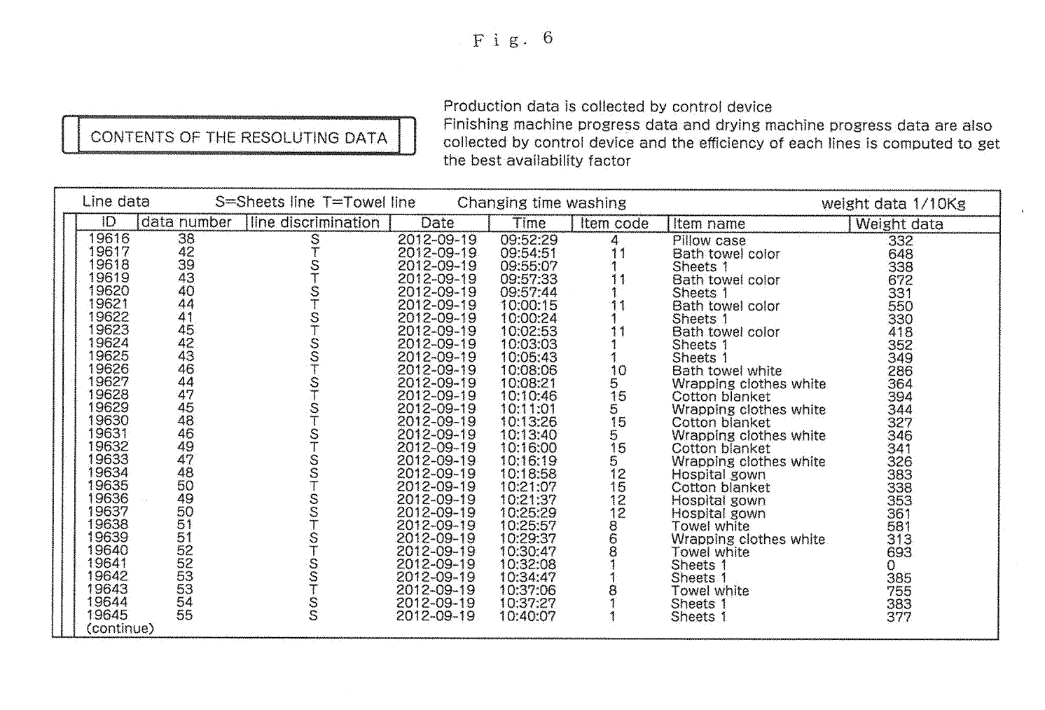

FIG. 6 is an obtained data showing the progress condition of the items to be charged into a first step in the embodiment according to the invention, wherein the data include the number of data, lane discrimination, date, operation time, item code, item name, weight data. T shows a process lane of Towel which should be programmed to be processed as the full dry items such as towels, pillow cover and bath mats in the following order; Packing→Charging conveyor→a first washing machine 2→Hydraulic dehydrator 3→Conveyor (Lifting & Traveling) L1→Dryer (2 Lots) 4→Conveyor (Distributing) C1→Towel folder 5→Finished product conveyor C3-1→Binding machine→Shipment waiting. On the other hand, S shows a process lane of Sheets which in a state of half dry for a kind of sheets, doctor's smock, hospital gowns and wrapping clothes, wherein the shake items such as sheets are programmed to be processed in the following order; Packing→Charging conveyor→a second washing machine 12→Hydraulic dehydrator 13→Conveyor (Lifting & Traveling) L1→Dryer (1 Lot) 14→Conveyor (Distributing) C2→Spreader 15→Roll 16→Folder 17→Finished product conveyor C3-2→Binding machine→Shipment waiting, while the doctor's smocks are programmed to be processed in the following order; Packing→Charging conveyor→the second washing machine 12→Hydraulic dehydrator 23→Conveyor→Dryer (1 Lot) 24→Wagon→Lift conveyor L3→Finishing room 25→Shipment waiting. However, it is difficult to analyze how the items are processed in each of steps even if all the data in all the steps can be obtained. Therefore, every one of the processing devices are provided with the following visualization devices in order to visualize the operation condition.

Visualization of Continuous Washing Process

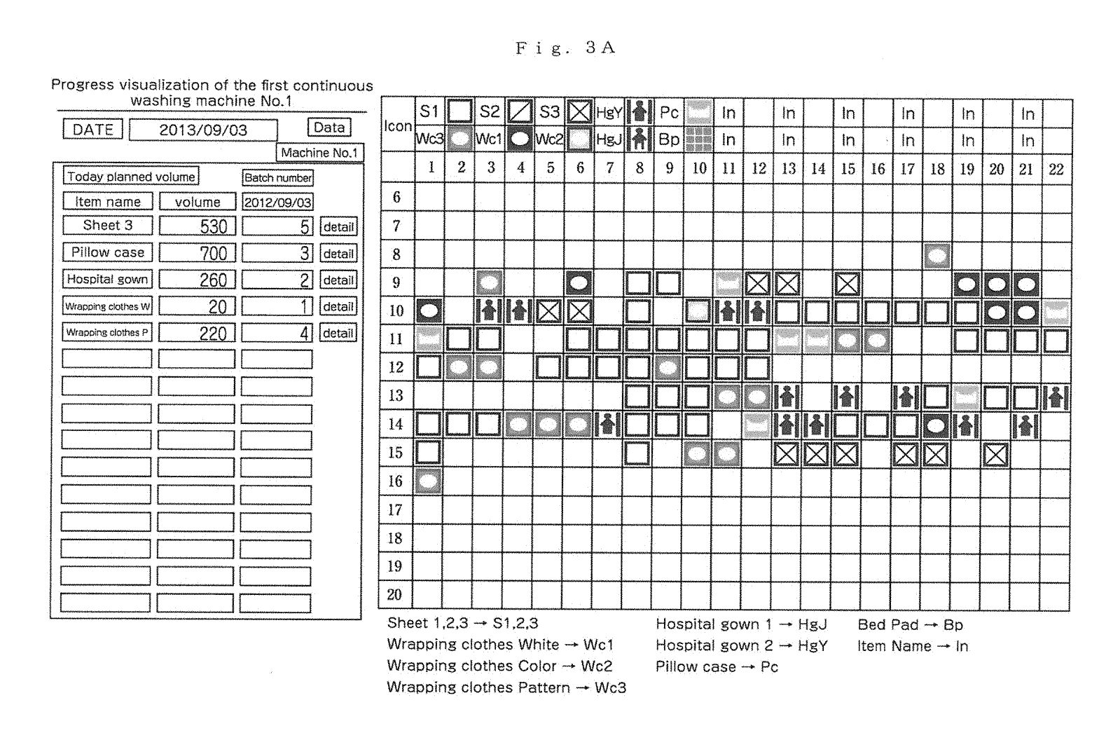

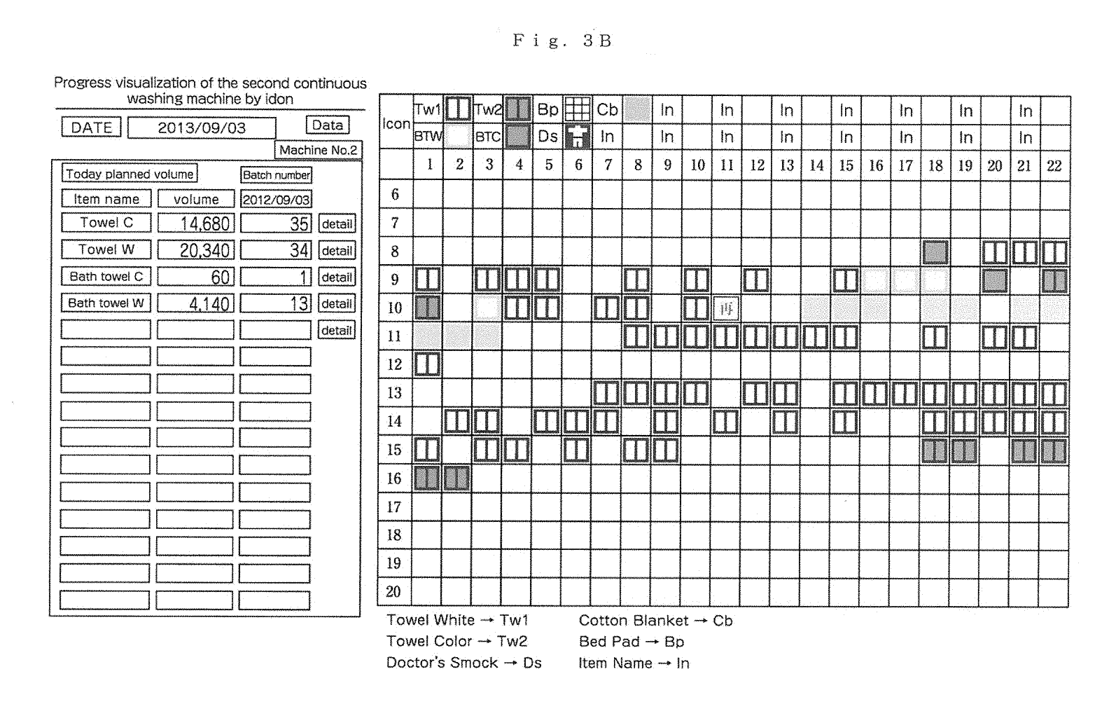

FIG. 3A is a plane view of a data recording matrix device according to the present invention device indicating a progress of a first continuous washing machines in the first step of the continuous processing system, while FIG. 3B is a plane view of a data recording matrix device according to the present invention device indicating a progress of a second continuous washing machines in the first step of the continuous processing system,

In the first continuous washing machine, 18 lots of first wrapping clothes in print were charged at 8 am, and 3 lots of second wrapping clothes in print were charged at 9 am, after 2 lots, 2 lots of white wrapping clothes and sheets of 1 lot were restlessly charged. No indication of icons in the cell shows no item to be charged. On the other hand, in the second continuous washing machines, 18 lots of bath towels and restlessly 20 to 4 lots of white towels

Were charged, after 1 lot, 3 lots of while towels were charged and then after 2 lots 2 lots of white towels were charged. Their continuous charging processes are shown in the matrix, wherein no icon in the cell shows no item to be charged.

According to the present invention, the visualization devices show the operation condition of the first and second continuous washing machines obviously just by looking.

Visualization of Dehydrating and Drying Process

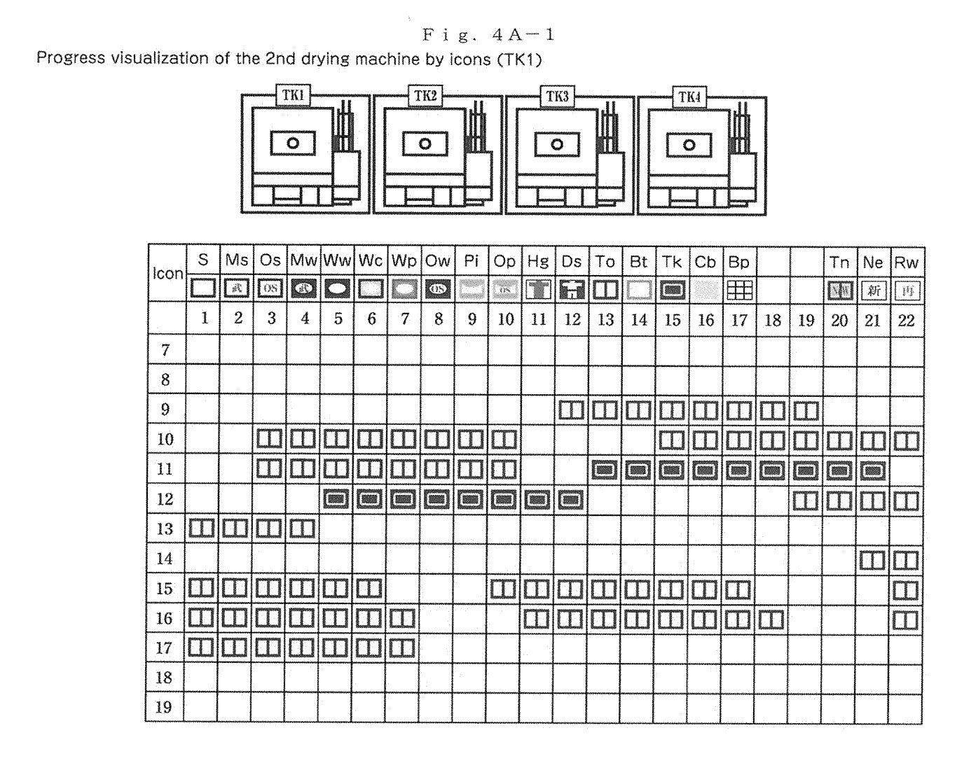

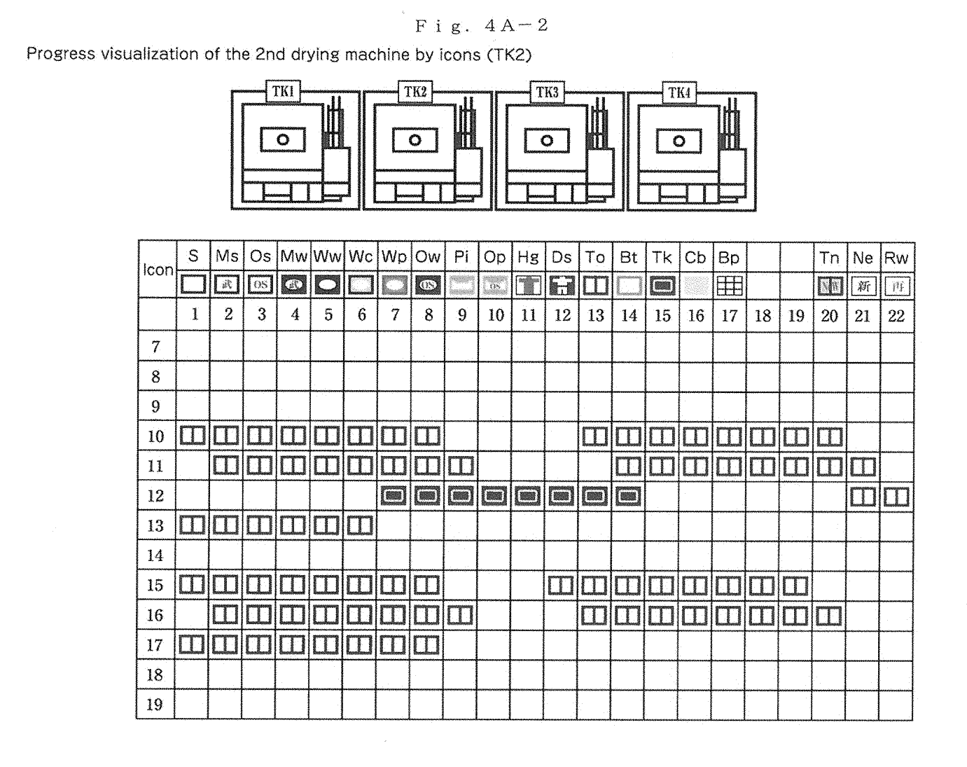

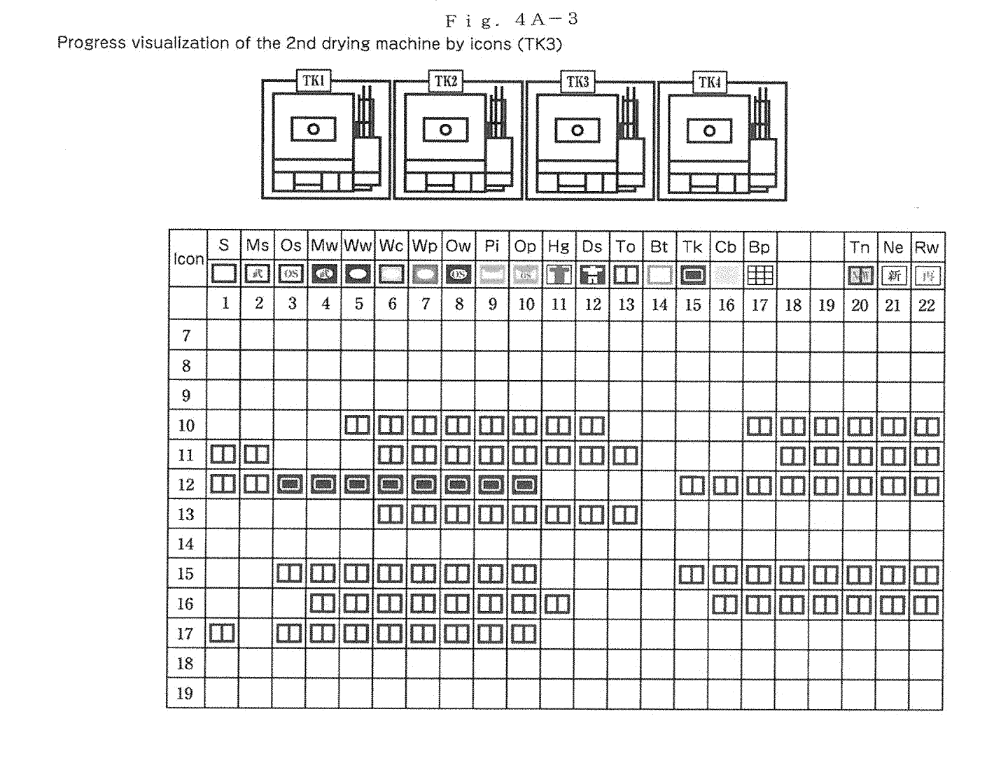

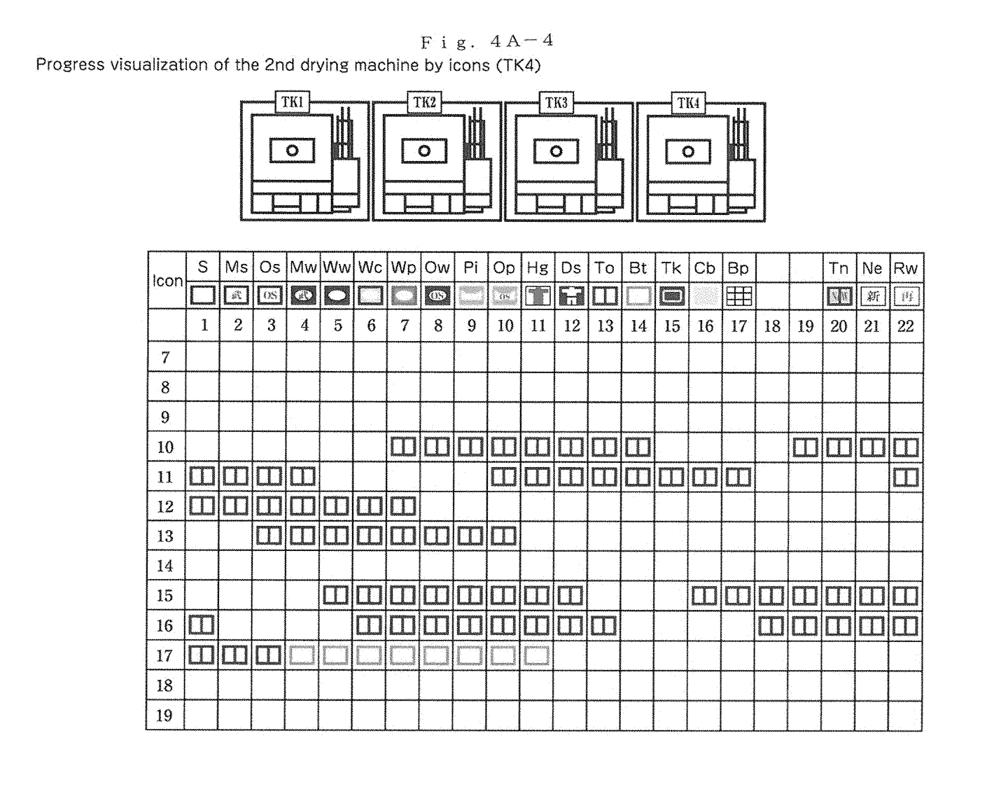

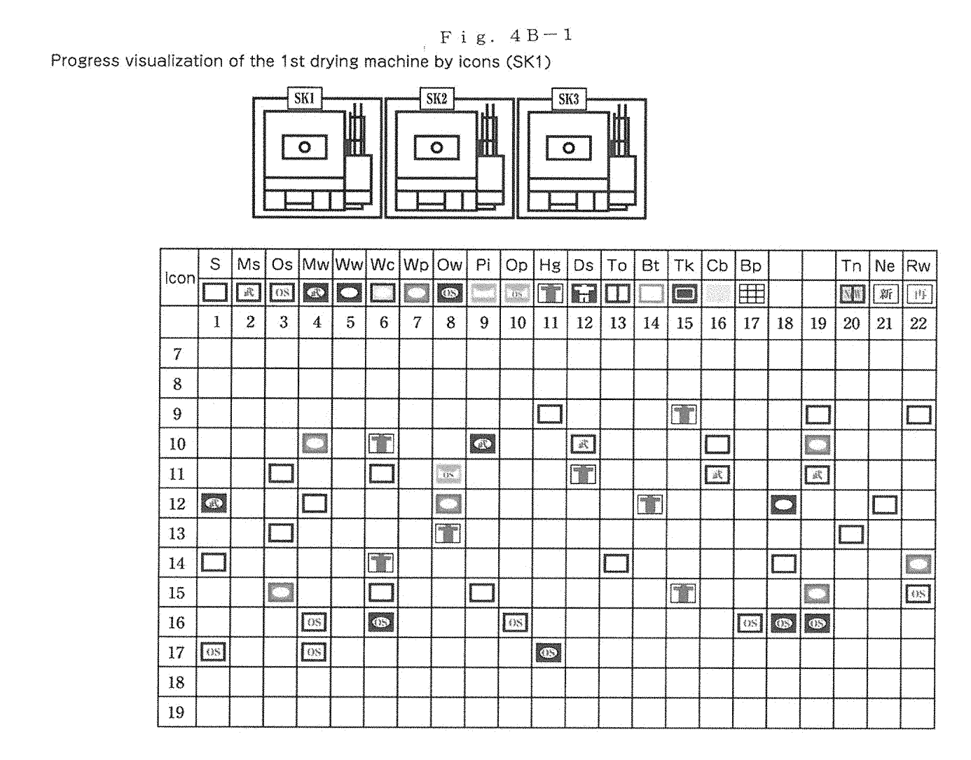

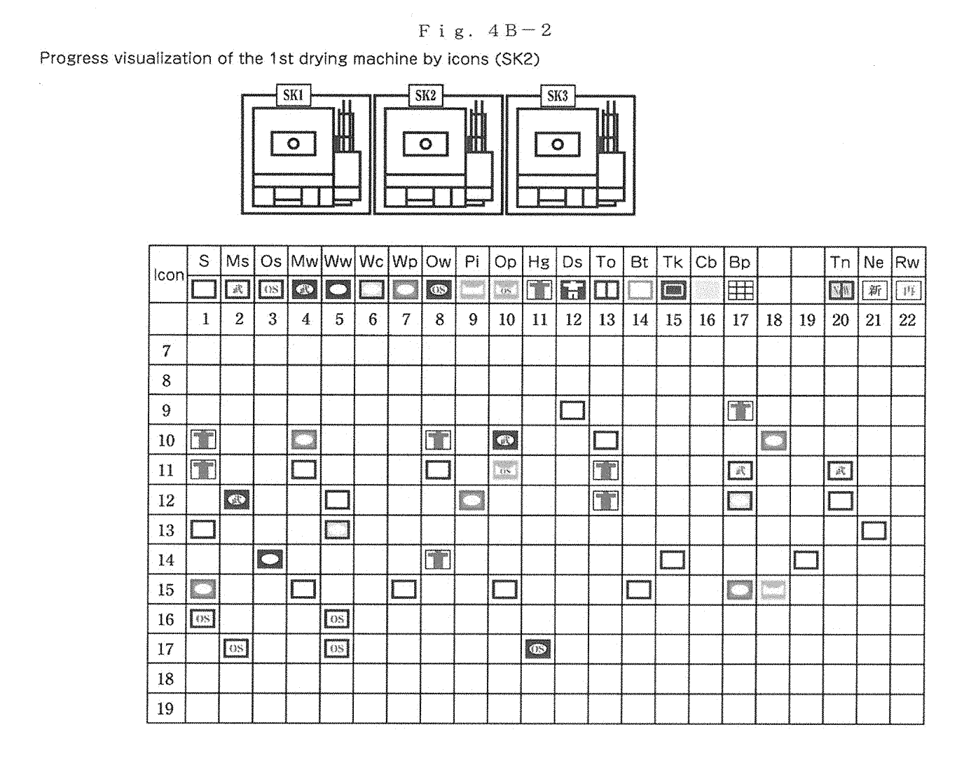

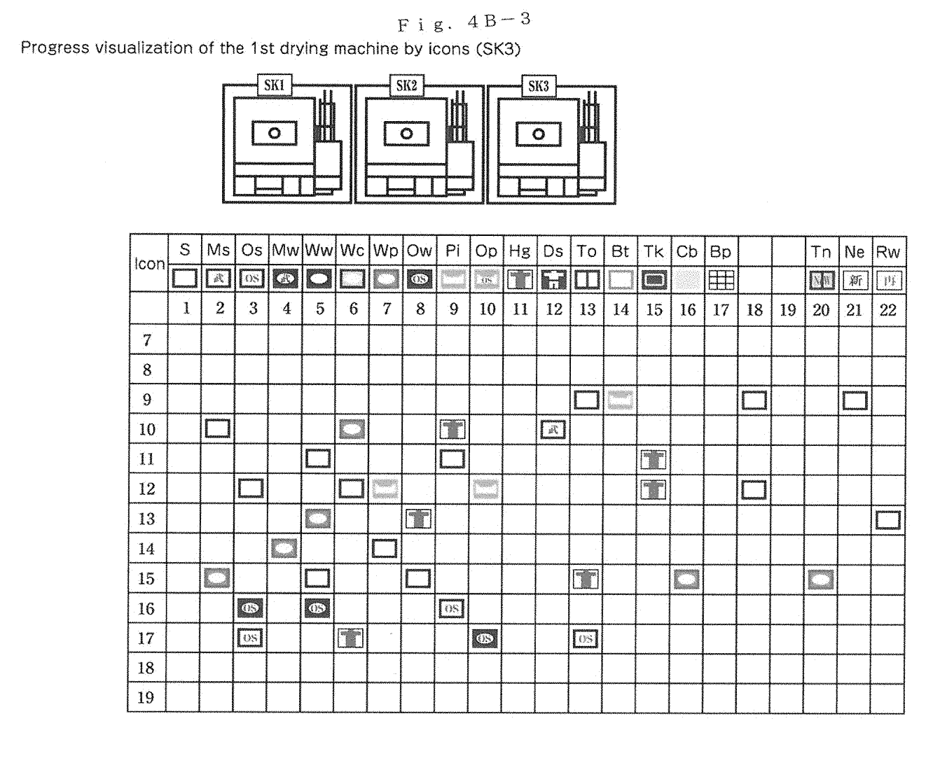

FIG. 4A-1 to 4A-4 are plane views of a data recording matrix device according to the present invention device indicating a progress of a first to a fourth drying machines for full drying item in the second step of the continuous processing laundry system, while FIG. 4B-1 to B-3 are plane views of a data recording matrix device according to the present invention device indicating a progress of a second drying machines for half drying item such as hospital gown or sheets in the second step of the continuous processing laundry system.

In the full drying step of towels, one batch of towel drying step need 8 lots of drying times. On the other hand, in the half drying step of Shake items, one lot of short drying step is necessary. The empty of cell shows no dry step at the present and in the past. Comparing the whole process at each operation times with the operation condition in the first washing step, if the items after drying is not transferred fast, there appear some waiting items on the conveyor before drying, resulting in cause of time lag in the continuous washing process and appearance of empty in the cell of the matrix. If the items to be processed are the same as the full dry items, they are subjected to a different drying operation so that the drying operation cannot catch up with the washing operation, resulting in existence of empty in the drying machines and wasted time on the operation. The operation condition can be visualized by icons indicating each items on the matrix. On the contrary, if almost of the items need a long drying time, there are items waiting on the conveyor from the continuous washing step to the drying step, resulting in the operation time loss causing washing waiting to the continuous washing step. According to the present invention, comparison the first step with the second step by visualization makes it easy to check the cause of the time lag and solve the problem.

Visualization in the Finishing Third Step

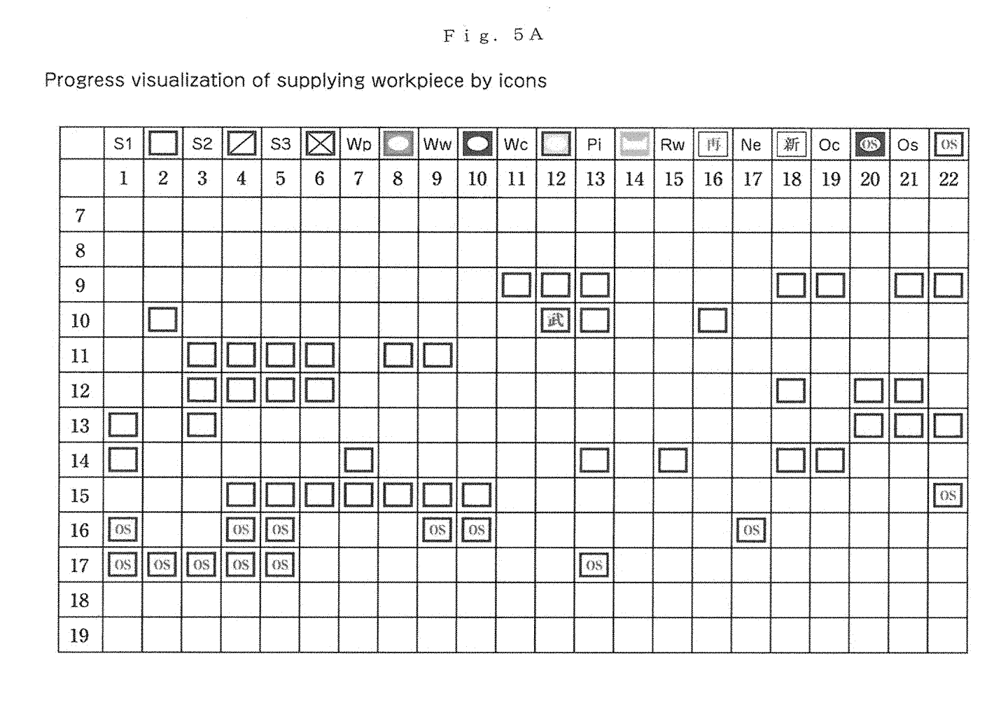

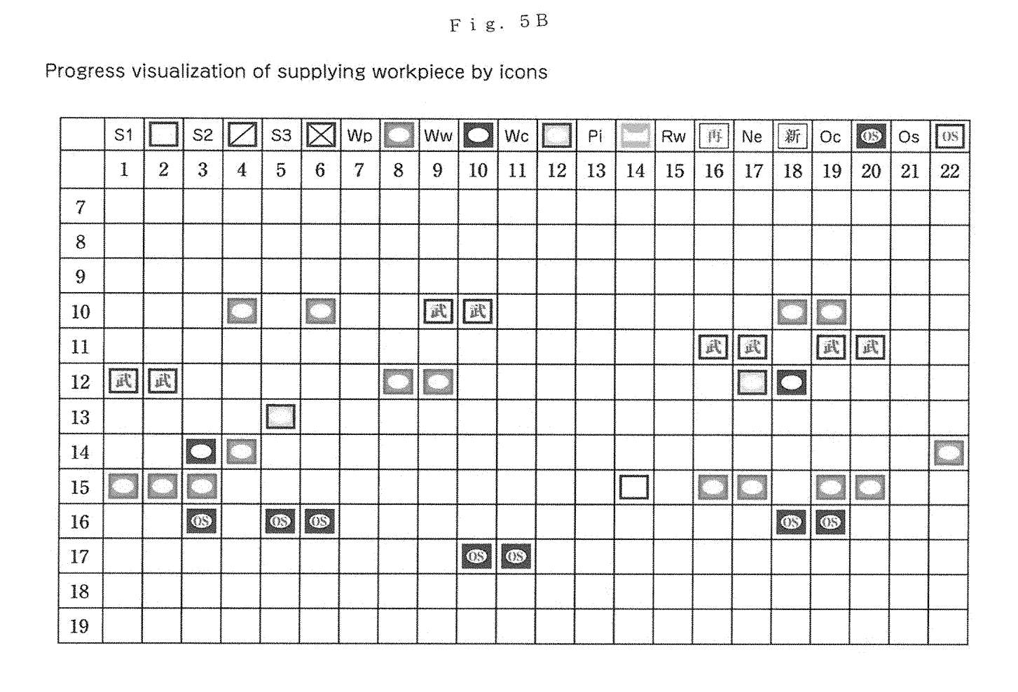

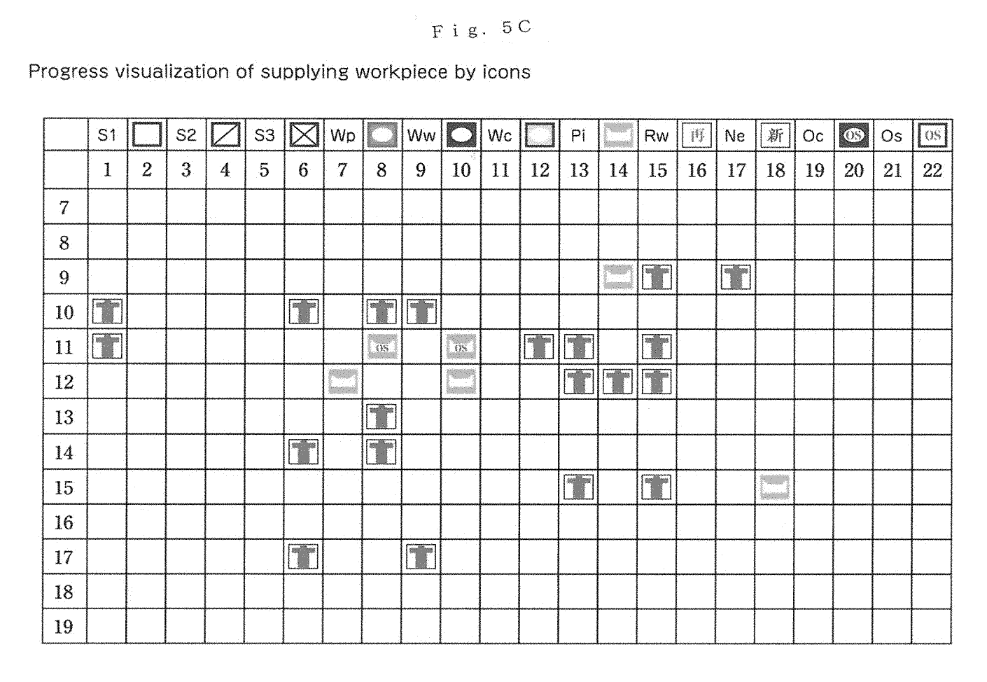

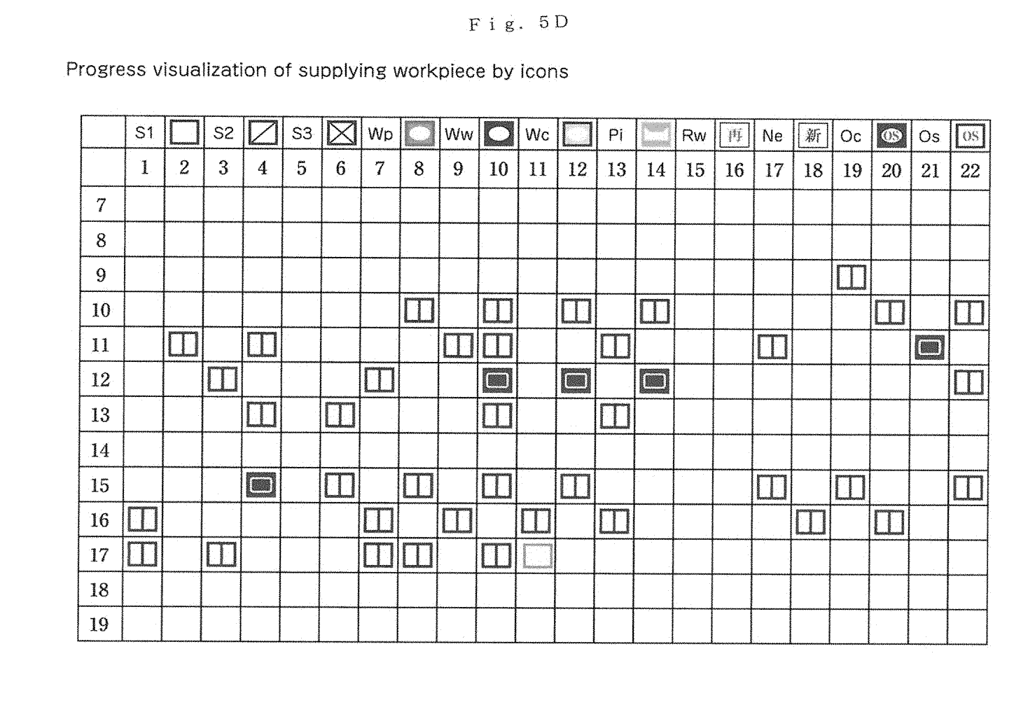

FIG. 5-A is a plane view of a data recording matrix device according to the present invention device indicating a progress of laundry folding machines for full drying item such as towels in the third step of the continuous processing laundry system,

FIG. 5-B is a plane view of a data recording matrix device according to the present invention device indicating a progress of a first finishing roll machines for half drying item such as sheets in the third step of the continuous processing laundry system,

FIG. 5-C is a plane view of a data recording matrix device according to the present invention device indicating a progress of a third finishing roll machines for half drying item such as wrapping cloth in the third step of the continuous processing laundry system,

FIG. 5-D is a plane view of a data recording matrix device according to the present invention device indicating a progress of a second finishing roll machines for half drying item such as hospital gown in the third step of the continuous processing laundry system,

In the finishing step, the items are usually done by manual. The half dry and shake washing items are processed in the same continuous washing machine because both are processed by the same after-treatment. The drying time are different each other. If consideration on the washing order is not enough, time lag of 40 to 60 minute will be made and a sufficient amount of the items cannot be fed to workers. In such cases, the inventive visualization device can make it clear whether the whole processes are effectively cooperated or not.

As summarized, to keep working effective or busy means to abide the first step processing time and then not to clog the conveyor with the items, not to make an empty in the dryers and to keep the item feed enough to workers. Therefore, visualization according to the invention makes it clear whether there are some empties in the matrix of the third step and depending on the empty condition of the matrix it is possible to control and keep the feed amount enough to the workers in the finishing step. Accompanied with visualization in the first and second step, it is possible to analyze the reason of exhibiting greater loss capability and to accumulate the data for amendment.

According to the inventive visualization device, visualization the number of the washing machines can be optimized and the amount of water, steam and electricity can be decreased and also the operation time can be shortened.

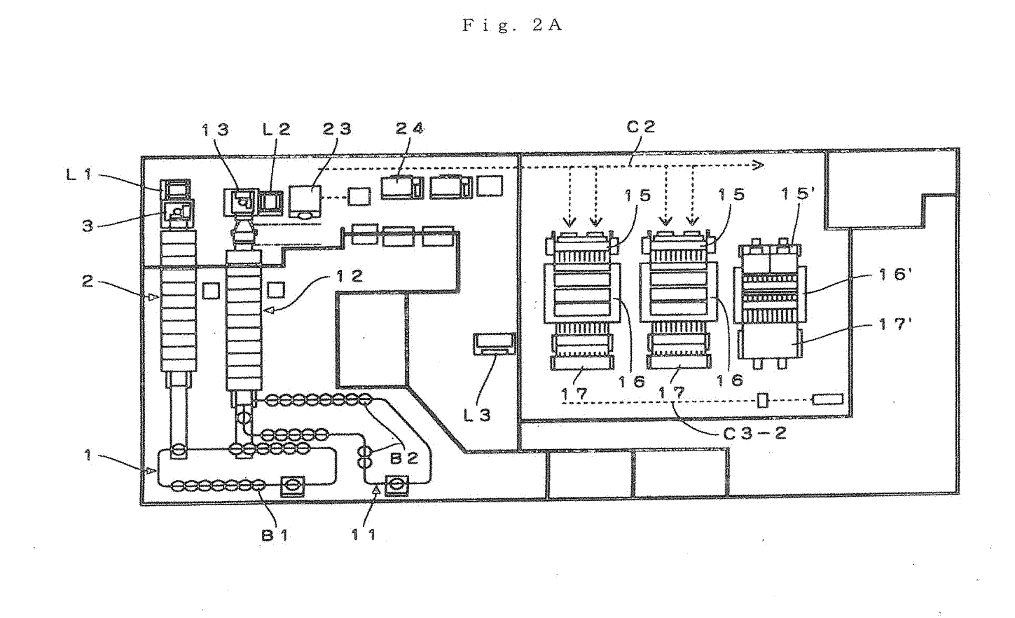

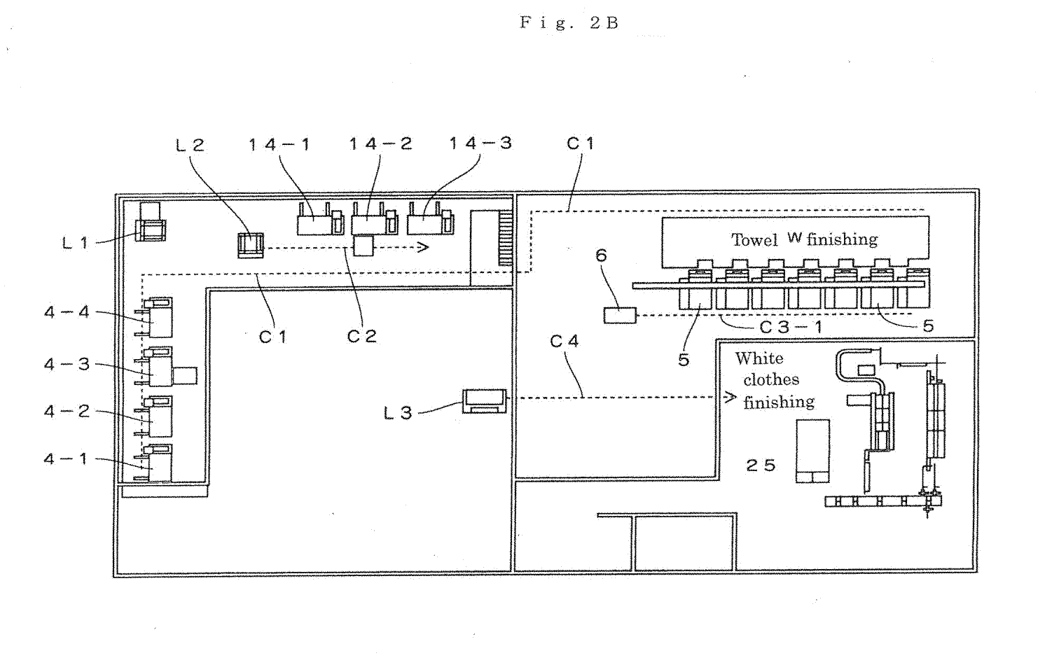

In FIGS. 1, 2A and 2B, the following numbers indicate respectively,
1, 11. - - - charging bag stock lane before washing
2, 12 - - - continuous washing machine
3, 13 - - - Dehydrator
L1, L3 - - - Lift conveyor
4, 14 - - - Dryer
C1˜C4 - - - Conveyor
6 - - - Binding machine
15 - - - Spreader
16 - - - Finishing roll
17 - - - Folder

1. A daily operation data recording matrix device for visually presenting and accumulating daily visual Icon data descriptive of process operations in the order of operational events in a continuous processing system, the daily operation data recording matrix device comprising:
an array including a two-dimensional matrix array made up of rows and columns,
one of the rows and columns in the matrix array being divided into hour units of a daily length of an operation and the others of such rows and columns being divided by a time span based on a length of one batch time of an operation work,
the rows and columns forming respective batch cells for indication of each of the process operations, and
the batch cells being used to visually accumulate by the visual Icons in the matrix array all the operation works in the order of the operational events.

2. The daily operation data recording matrix device according to claim 1,
wherein the continuous processing system is a continuous washing system including at least a sorting step of laundries, a washing step of laundries, a drying step of laundries, and a finishing step of laundries.

3. The daily operation data recording matrix device according to claim 2,
wherein the sorting step of laundries includes at least two stock lanes and the soiled laundries are sorted before washing into two groups, one being a kind for full drying items and the other being a kind for semi-drying items.

4. A method of optimizing the daily operation in a continuous washing system including at least a sorting step of laundries, a washing step of laundries, a drying step of laundries, and a finishing step of laundries and the steps are all being controlled, the method comprising:
a step of providing a daily operation recording matrix device according to claim 1 for the first washing step;
a step of recording each daily washing process operations into one of the rows and columns of the matrix device in the order of washing events in the first washing step;
a step of visually accumulating each daily washing process operations in one of rows and columns divided by the time span based on the length of one batch time of the operation work;
a step of comparing the batch cell or cells filled by each of the washing events Icon with the batch cell or cells not filled by the Icon; and
a step of evaluating a visual result or history of the washing operation.

5. The method of optimizing the daily operation in a continuous washing system according to claim 4,
wherein the step of evaluating a visual result or history of the washing operation is carried out by optical judging or analyzing whether the number of no filled batch cells are much more or not than those in a case of a controlled washing.
